(19) United States
(12) Patent Application Publication
(10) Pub. No.: US 2016/0253241 A1
(43) Pub. Date: Sep. 1, 2016

(54) INSTANT STREAMING OF THE LATEST VERSION OF A FILE

(71) Applicant: LONGSAND LIMITED, Cambridge, Cambridgeshire (GB)

(72) Inventor: Saurabh Gupta, Bangalore (IN)

(21) Appl. No.: 15/032,894

(22) PCT Filed: Oct. 28, 2013
(86) PCT No.: PCT/EP2013/072524

§ 371 Date: Apr. 28, 2016

(51) Int. Cl. G06F 11/14; G06F 17/30

(52) U.S. Cl. CPC G06F 11/1451; G06F 17/30132; G06F 17/30194; G06F 2201/84

(57) ABSTRACT

A system is described herein. The system includes a backup server for backing up user files. The backup server includes a storage device for storing a base file corresponding to a first backup instance of a file and deltas that represent changes to the file. The backup server also includes a file backup manager that receives the base file and the deltas from a user's computing device; wherein deltas are received on subsequent operations pertaining to the file. A file reconstruction manager is included that generates a tip version of the file from the base file and the deltas, and sends the tip version to the user's computing device. Additionally, the backup server includes a cache memory that stores the tip version so that it is available for subsequent downloads corresponding to additional requests for the file.

### BACKGROUND

In some instances, backup software solutions provide a syncing functionality. Specifically, the syncing functionality ensures that each file is updated according to established rules. The files may be copied from a source location to one or more target locations, with no files copied back to the source location. In other scenarios, updated files may be copied to both a target location and a source location. Each of the source location and the target location is maintained such that they are identical to each other. Other backup solutions may maintain multiple versions of the electronic information that is stored using the backup solution.

### BRIEF DESCRIPTION OF THE DRAWINGS

Certain examples are described in the following detailed description and in reference to the drawings, in which:

FIG. 1 is a block diagram of a computing device that may instantly stream the latest version of a file;

FIG. 2 is a process flow diagram that instantly streams or transmits the latest version of a file;

FIG. 3 is a process flow diagram that instantly streams or transmits the latest version of a file; and

FIG. 4 is a block diagram showing tangible, non-transitory, computer-readable media that instantly streams the latest version of a file.

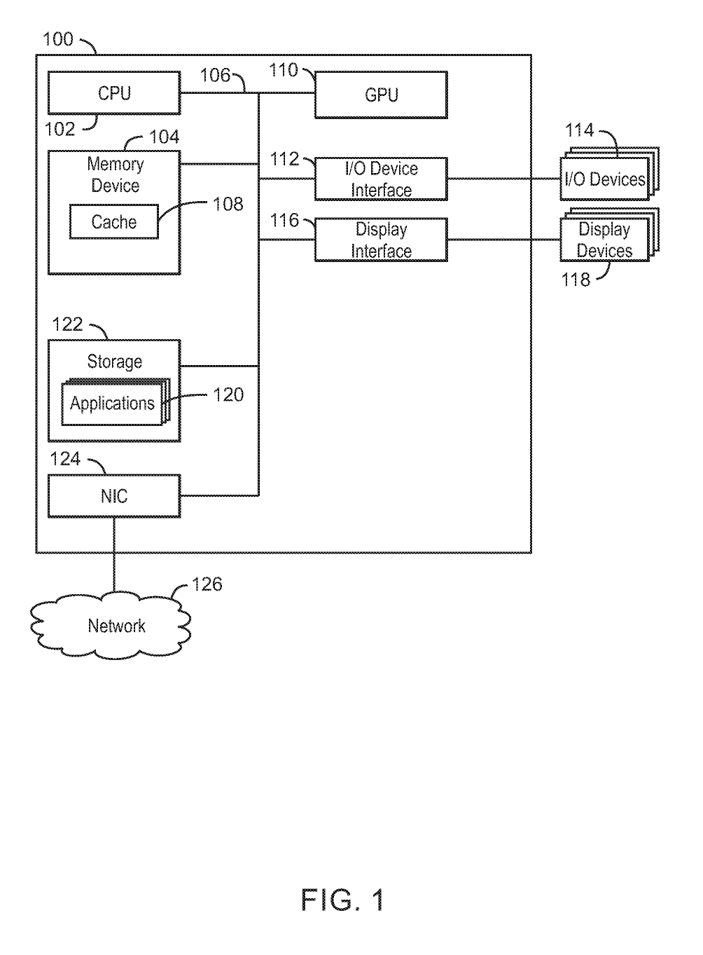

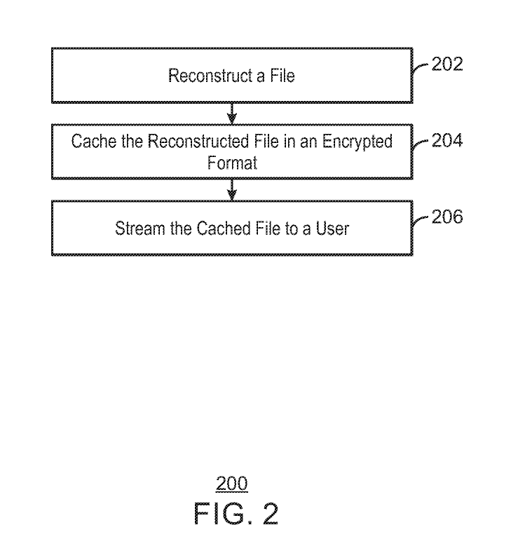

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION OF SPECIFIC EXAMPLES

As discussed above, backup solutions are used to backup electronic information. Some backup solutions may maintain multiple versions of the backed up information. As used herein, the electronic information described can be documents, presentations, audio data, video data, images, any data stored electronically, or any combination thereof. The electronic information may also be referred to as a file. Multiple versions of the backed up files may be maintained by storing a base version of the file followed by any number of incremental deltas. In some cases, each delta contains the changes made to the base version of the file. A backup client sends deltas for storage whenever the file is modified. Over a period of time, hundreds of deltas may be generated, distributed in different files and resources all over the file system. As a result, when a user attempts to retrieve the latest version of the file, it may take a while to reconstruct the file starting with the base version and then adding the deltas to the base version. The time it takes to reconstruct the latest version of the file may negatively affect the overall user experience. Since most users ask for the latest version of a file, the present techniques can optimize that behavior of the backup system with respect to obtaining the latest version of the file.

Embodiments described herein provide the latest version of a file instantly. In embodiments, the time consumed in file reconstruction is eliminated. Furthermore the file may be stored in a cache, resulting in quicker access to the file when compared to other memory and storage devices. As a result, the workload of a computing device may be reduced, as the server does not reconstruct the file each time it is streamed to a user. For ease of description, the present techniques are described using a backup solution. However, the present techniques may apply to any information management system. Accordingly, the present techniques may be used with version control systems as well as distributed database systems.

FIG. 1 is a block diagram of a computing device 100 that may instantly stream the latest version of a file. In some cases, the latest version of a file has the most recent modifications and may be referred to as the tip version of the file. The computing device 100 may be, for example, a laptop computer, desktop computer, tablet computer, mobile device, or server, among others. The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the computing device 100 may include more than one CPU 102. The instructions that are executed by the CPU 102 may be used to implement instant streaming of the latest version of a file. The memory device 104 can include random access memory (RAM), read only memory (ROM), flash memory, or any other suitable memory systems. For example, the memory device 104 may include dynamic random access memory (DRAM). In some embodiments, the memory device includes a cache 108 that is used to cache the tip version of the file. In some embodiments, the cache 108 is a smaller, faster area of memory that can be accessed quicker than other storage or memory devices. In some embodiments, the cache may be located outside of the memory device 104.

The CPU 102 may be connected through the bus 106 to an input/output (I/O) device interface 112 configured to connect the computing device 100 to one or more I/O devices 114. The I/O devices 114 may include, for example, a keyboard and a pointing device, wherein the pointing device may include a touchpad or a touchscreen, among others. The I/O devices 114 may be built-in components of the computing device 100, or may be devices that are externally connected to the computing device 100.

The CPU 102 may also be linked through the bus 106 to a display interface 116 configured to connect the computing device 100 to display devices 118. The display devices 118 may include a display screen that is a built-in component of the computing device 100. The display devices 118 may also include a computer monitor, television, or projector, among others, that is externally connected to the computing device 100.

The computing device also includes a storage device 120. The storage device 120 is a physical memory such as a hard drive, an optical drive, a thumbdrive, an array of drives, or any combinations thereof. The storage device 120 may also include remote storage drives. The storage device 120 includes any number of applications 126 that are configured to run on the computing device 100. The applications 126 may enable user access to files stored on the computing device 100. In some embodiments, the storage device may store a base file that corresponds to a first backup instance of a file and deltas that represent changes to the file. In particular, a file backup manager can receive the base file and the deltas from a user's computing device. The deltas are typically received on subsequent operations pertaining to the file. For example, the deltas may be received when changes are made to the file, or when a different version of the file is backed up. A file reconstruction manager generates a tip revision of the file from the base file and the deltas. The tip revision may be sent to the user's computing device and a cache memory may store the tip revision so that it is available for subsequent downloads corresponding to additional requests for the file.

The computing device 100 may also include a network interface controller (NIC) 124 may be configured to connect the computing device 100 through the bus 106 to a network 126. The network 126 may be a wide area network (WAN), local area network (LAN), or the Internet, among others. The block diagram of FIG. 1 is not intended to indicate that the computing device 100 is to include all of the components shown in FIG. 1. Further, the computing device 100 may include any number of additional components not shown in FIG. 1, depending on the details of the specific implementation.

In a backup solution, a file is created when it is backed up to the target location from the source location for the first time. In a version control system, a file is created when a user initially saves the file within the version control system. Similarly, is a distributed database, a file is created when a user initially saves the file within the distributed database. In any case, as discussed above, the initial version of the file is the base version of the file. The base file may be accessed by other users, and any change to the base file is stored as an incremental delta. In this manner, each delta creates a branch from the base file to the delta. Each delta can have additional branches to other deltas within the system. The end of each branch is referred to as the tip. In other words, the latest version of the file, the tip version, can be found at the end of each branch.

In some cases, a user can access the file at any point in history by requesting access to various deltas along a branch. The time to access the file depends on the point at which the user accesses the file along each branch. Typically, users will access the tip version of the file, which is associated with the longest reconstruction time, as the tip version of the file includes all previous deltas along a particular branch.

FIG. 2 is a process flow diagram 200 that instantly streams or transmits the latest version of a file. In some embodiments, a user has a backup set that consists of files to be backed up. The files in the backup set can be documents, images, audio, video, source code, software code, any other file, or any combination thereof.

At block 202, the file is reconstructed. Some backup solutions may store a base version of the file, followed by incremental deltas. In some cases, the base file is received by a backup file manager. The base file may also be stored on a storage device along with the deltas that represent changes to the file. Version control systems as well as distributed databases may also store base versions of a file along with incremental deltas at various storage locations. The base version of the file is the initial version of the file that was stored when the file was backed up for the first time. Each delta is a modification to the file, and may include various additions, deletions, or rearrangements of the file. Accordingly, the file may be reconstructed or built using a base version of the file and at least one delta. In some embodiments, the file is reconstructed prior to any requests for the latest version of the file. Additionally, in some embodiments, the file is reconstructed when the first delta is available. The reconstruction of the file may be a configurable option within a computing device. For example, file reconstruction may be enforced even for files that are not downloaded by a user. Such a scenario may reduce system performance, as each file is reconstructed regardless of if a user has accessed the file. Accordingly, by considering system performance when developing rules for file reconstruction, the system can be configured differently across various implementations.

At block 204, the reconstructed file is cached. In embodiments, the reconstructed file is the tip version of the file. In some cases, caching the file refers to storing the file in a cache, such that the file is accessed in the cache faster than if the file was stored in other storage locations. Accordingly, the file may be saved using any memory location with a low latency, and the tip version of the file is available for subsequent downloads corresponding to additional requests for the file. The cached tip version of the file will be replaced with new tip version as soon as new delta is available for that file. In embodiments, before caching the file, the file is downloaded by a user from the server at least once. Caching the tip version of the file on the server ensures that no further streaming of the tip version of the file has to wait for file reconstruction and that streaming of the tip version of the file can start instantly.

At block 206, the cached file is streamed to a user. The cached file may be streamed to a user without a time delay to reconstruct the file, since the tip version of the file is cached and the file can be streamed immediately. In this manner, the user requesting the file does not need to wait for the file to be reconstructed which results in a better user experience. Moreover, when the file is cached on a memory with low latency, the cached file may be transmitted to a user more quickly since a cache gives quicker access to the file when compared to other memory and storage devices. A workload on the system of the target location may be reduced, as the system does not reconstruct the same file multiple times. Additionally, if the file is corrupt, notification that the file is corrupt may be sent to a user immediately rather than after the time consuming file reconstruction process.

The techniques described herein enable instant streaming of a cached file to a user, without sending the entire file to a target location. Rather, the file may be reconstructed at the target location based upon various rules and policies at the target location. For example, the file may be reconstructed and cached after the number of deltas available for reconstruction exceeds a threshold. In some cases, the threshold may be a pre-determined threshold. Additionally, in some cases, the threshold may be determined by an administrator of the system. The rules and policies used to build and save the files or electronic information at the target location may be based on capabilities of the target location. For example, if storage is limited at the target location, there may be less space available to store the deltas used to reconstruct the file. In such an example, the number of deltas to meet the threshold for reconstruction may be lower compared to a target location with a large amount of storage available for the deltas used in reconstruction. Additionally, the space available for the cache of reconstructed files may result in cached file being restricted to a certain size based on the available space.

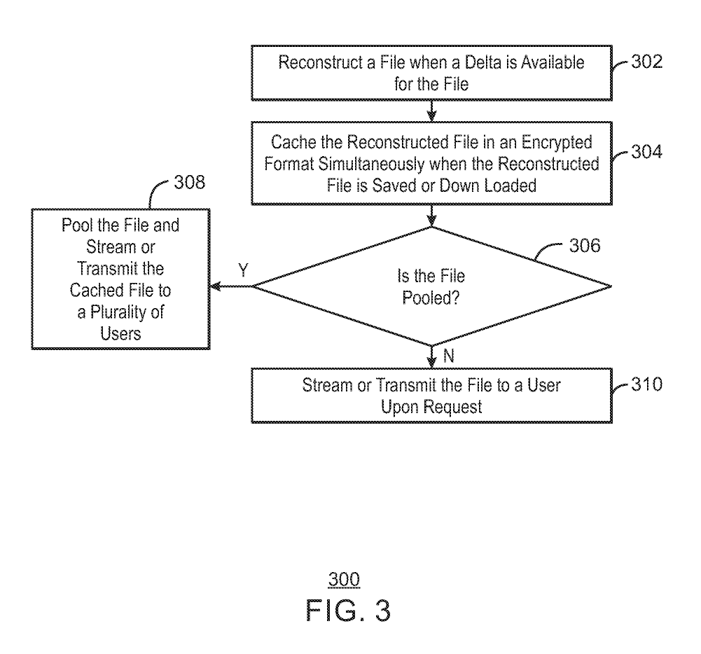

FIG. 3 is a process flow diagram 300 that instantly streams or transmits the latest version of a file. At block 302, the file is reconstructed when a delta is available for the file. At block 304, the reconstructed file is cached in an encrypted format. The reconstructed file may be cached simultaneously when the reconstructed file is saved or downloaded. In some embodiments, the reconstructed file is cached after a number of versions is greater than a pre-defined threshold. Additionally, in some embodiments, the reconstructed file is cached according to the caching space available, and the reconstructed file may be cached on an exclusive storage device. The exclusive storage device may be a solid state drive or any other storage device. When the exclusive storage device is a solid state drive, the input/output latency may be eliminated as there are no rotating disks or platters when accessing data on the solid state drive.

At block 306, it is determined if the file is to be a pooled file. If the file is to be a pooled file, process flow continues to block 308. If the file is not a pooled file, process flow continues to block 310. In some cases, a pooled file is a file that is shared by a plurality of users. At block 308, the file is pooled such that it is available to a plurality of users. The file may be streamed or transmitted to a plurality of users. In this manner, caching of the reconstructed file occurs once, and the plurality of users who share the pooled file will access the same cached tip version of the file. This results in real time collaboration that occurs seamlessly without any delay.

In the event of a pooled file, a number of deltas may be created by the plurality of users that access the cached tip version of the file. Each user may make modifications to the tip version of the file. After each user stores their respective modifications, there may be multiple deltas to the tip version of the file. In some cases, each delta from the plurality of users may be merged to generate one delta for the file. The generated delta may then be used to create a new tip version of the file, and the new tip version of the file may be cached as described above.

In embodiments, each delta from the plurality of users may be used to create an independent tip version of the file for that user. A user may indicate that the modifications contained within that user's delta should not be merged or combined with other modifications, and that a new file should be created. The file may also be designated as a new base file, with branches and deltas independent from the original base file.

At block 310, the cached file is streamed to a user upon request from the user. In some cases, the cached file may be a cached file that includes the merged deltas from a plurality of users. After the user has requested the download of the file, it is immediately streamed or transmitted to the user without any delay in reconstructing the file with one or more deltas.

The process flow diagrams in FIG. 2 and FIG. 3 are not intended to indicate that each of the process flow diagram 200 and the process flow diagram 300 are to include all of the components shown in FIG. 2 and FIG. 3. Further, the process flow diagram 200 and the process flow diagram 300 fewer or more blocks than what is shown, and blocks from the process flow diagram 200 may be included in the process flow diagram 300, and vice versa, depending on the details of the specific implementation.

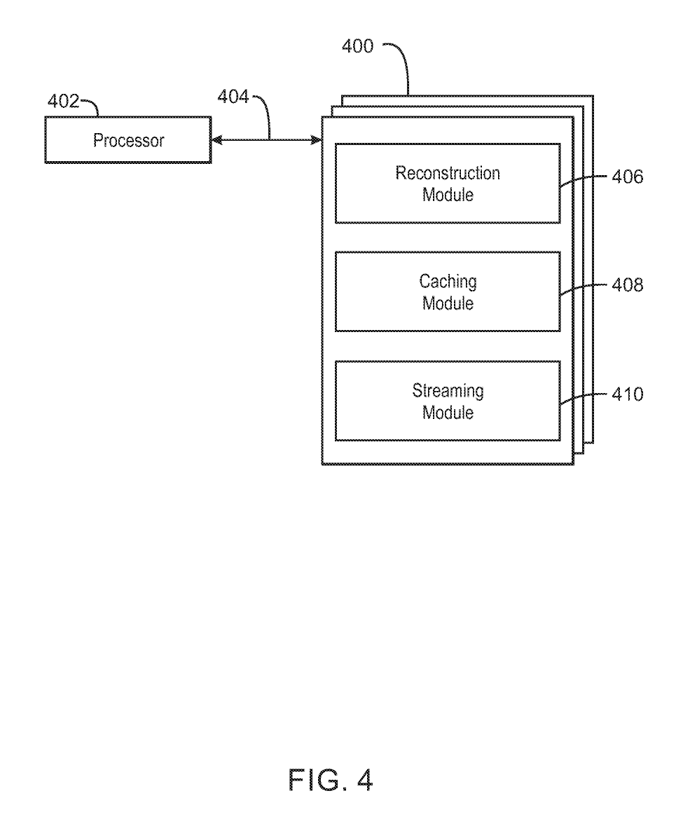

FIG. 4 is a block diagram showing tangible, non-transitory, computer-readable media 400 that instantly streams the latest version of a file. The computer-readable media 400 may be accessed by a processor 402 over a computer bus 404. Furthermore, the computer-readable media 400 may include code to direct the processor 402 to perform the steps of the current method.

The various software components discussed herein may be stored on the tangible, non-transitory, computer-readable media 400, as indicated in FIG. 4. For example, a reconstruction module 406 may be configured to direct the processor 402 to reconstruct the file. A caching module 408 may be configured to direct the processor 402 to cache the reconstructed file. In examples, the cached tip version of the file will be replaced with new tip version as soon as new delta is available for that file. A streaming module 410 may be configured to direct the processor 402 to stream or transmit the file to a user.

It is to be understood that FIG. 4 is not intended to indicate that all of the software components discussed above are to be included within the tangible, non-transitory, computer-readable media 400 in every case. Further, any number of additional software components not shown in FIG. 4 may be included within the tangible, non-transitory, computer-readable media 400, depending on the specific implementation.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

1. A system, comprising:
a backup server for backing up user files, the backup server comprising:
a storage device for storing a base file corresponding to a first backup instance of a file and deltas that represent changes to the file;
a file backup manager that receives the base file and the deltas from a user's computing device, wherein deltas are received on subsequent operations pertaining to the file;
a file reconstruction manager that generates a tip version of the file from the base file and the deltas, and sends the tip version to the user's computing device; and
a cache memory that stores the tip version so that it is available for subsequent downloads corresponding to additional requests for the file.

2. The system of claim 1, wherein the tip version of the file is replaced with a new version of the file that includes an additional delta when a new delta is available for the file.

3. The system of claim 1, wherein the tip version of the file is saved in an encrypted format.

4. The system of claim 1, wherein the tip version of the file is saved simultaneously when the latest version of the file is built.

5. The system of claim 1, further comprising pooling the tip version of the file, wherein the file is built, then streamed to a plurality of users.

6. The system of claim 1, wherein the base file is used to generate the tip version of the file after a number of deltas exceeds a pre-defined threshold.

7. The system of claim 1, wherein the base file is reconstructed according to an amount of space allocated for the file.

8. The system of claim 1, wherein the base file is saved in a distributed database system.

9. A method for instantly streaming the latest version of a file, comprising:
reconstructing the file, wherein the file is reconstructed using a base file and a delta;
caching the reconstructed file in response to a request to store the delta; and
streaming the cached file to a user without a time delay to reconstruct the file.

10. The method of claim 9, wherein the reconstructed file is updated within the cache when a delta is available for the file.

11. The method of claim 9, wherein the file is cached in an encrypted format.

12. The method of claim 9, wherein the file is cached simultaneously when the file is reconstructed.

13. The method of claim 9, further comprising pooling the file, wherein the reconstructed file is streamed to a plurality of users in response to a request from each of the plurality of users.

14. The method of claim 9, wherein the reconstructed file is cached in response to a number of available deltas number greater than a threshold.

15. A tangible, non-transitory, computer-readable medium comprising code to direct a processor to:
reconstruct the electronic information from a source location at a target location;
cache the reconstructed electronic information at the target location, such that the electronic information is instantly accessible; and
stream the cached electronic information to a user instantly upon request from a user.

16. The system of claim 1, wherein the tip version is instantly streamed from the backup server to the user's computing device.

17. The system of claim 1, wherein the tip version is generated once, stored once, and a same tip version of the file is transmitted for each additional request.

18. The method of claim 9, wherein the file is reconstructed based on policies at a target location, wherein the policies are based on capabilities of the target location.

19. The method of claim 9, wherein the file is reconstructed in response to an availability of the delta.

20. The computer-readable medium of claim 15, wherein the electronic information is reconstructed based on policies at the target location, wherein the policies are based on capabilities of the target location.
